(19) United States
(12) Patent Application Publication
(10) Pub. No.: US 2025/0067982 A1
(43) Pub. Date: Feb. 27, 2025

(54) CONTROLLABLE APERTURE PROJECTION FOR WAVEGUIDE DISPLAY

(71) Applicant: Meta Platforms Technologies, LLC, Menlo Park, CA (US)

(72) Inventors: Changwon JANG, Bellevue, WA (US); Te HU, San Jose, CA (US); Jianing YAO, San Jose, CA (US); Dongmin YANG, San Jose, CA (US); Ajit NINAN, San Jose, CA (US); Alexandre CHAPIRO, San Carlos, CA (US)

(73) Assignee: Meta Platforms Technologies, LLC, Menlo Park, CA (US)

(21) Appl. No.: 18/811,361

(22) Filed: Aug. 21, 2024

Related U.S. Application Data
(60) Provisional application No. 63/578,583, filed on Aug. 24, 2023.

(51) Int. Cl. G02B 27/01; G02B 5/20; G02B 27/00; G02B 27/09

(52) U.S. Cl. CPC G02B 27/0172; G02B 5/208; G02B 27/005; G02B 27/0093; G02B 27/0988; G02B 2027/0138

(57) ABSTRACT

A head-mounted display device employs controllable aperture projection for uniformity of a waveguide display within a field of view and eyebox domain. A waveguide-based display to control pupil replication density may comprise an image panel to provide light, a projection lens to receive and focus the light from the image panel, a variable aperture to pass the focused light in a controllable manner, and a waveguide to project the focused light passed through by the variable aperture onto an eye box, wherein the variable aperture is positioned at an entrance of the waveguide.

### PRIORITY

This patent application claims priority to U.S. Provisional Patent Application No. 63/578,583, entitled “Controllable Aperture Projection for Waveguide Display,” filed on Aug. 24, 2023, the disclosure of which is hereby incorporated by reference in its entirety.

### TECHNICAL FIELD

This patent application relates generally to display devices, and in particular, to improvement of uniformity of a waveguide display within a field of view and eyebox domain, to correction of color non-uniformity artifacts that are generated by waveguides, and to a bifocal mixed reality pass-through camera with partial imaging areas focused at different distances.

### BACKGROUND

With recent advances in technology, prevalence and proliferation of content creation and delivery have increased greatly in recent years. In particular, interactive content such as virtual reality (VR) content, augmented reality (AR) content, mixed reality (MR) content, and content within and associated with a real and/or virtual environment (e.g., a “metaverse”) has become appealing to consumers.

To facilitate delivery of this and other related content, service providers have endeavored to provide various forms of wearable display systems. One such example may be a head-mounted display (HMD) device, such as a wearable eyewear, a wearable headset, or eyeglasses. Head-mounted display devices (HMDs) require smaller size, weight, and limited power consuming components. Thus, there may be a trade-off between capabilities of various display and detection components used in a head-mounted display (HMD) device and their physical characteristics.

A head-mounted display (HMD) device may project or direct light to display virtual objects or combine images of real objects with virtual objects, as in virtual reality (VR), augmented reality (AR), or mixed reality (MR) applications. For example, in an augmented reality (AR) system, a user may view both images of virtual objects (e.g., computer-generated images (CGIs)) and the surrounding environment. Head-mounted display (HMD) devices may also present interactive content.

### BRIEF DESCRIPTION OF DRAWINGS

Features of the present disclosure are illustrated by way of example and not limited in the following figures, in which like numerals indicate like elements. One skilled in the art will readily recognize from the following that alternative examples of the structures and methods illustrated in the figures can be employed without departing from the principles described herein.

FIG. 1 illustrates a block diagram of an artificial reality system environment including a near-eye display, according to an example.

FIG. 2 illustrates a perspective view of a near-eye display in the form of a head-mounted display (HMD) device, according to an example.

FIGS. 3A and 3B illustrate a perspective view and a top view of a near-eye display in the form of a pair of glasses, according to an example.

FIG. 4A illustrates a waveguide display projecting content from an image panel to an eye.

FIGS. 4B through 4D illustrate various configurations of a variable aperture implemented in a waveguide display projecting content from an image panel to an eye, according to examples.

FIGS. 5A through 5C illustrate synchronization of a variable aperture implemented in a waveguide display projecting content from an image panel to an eye with the image panel or a controlled backlight, according to examples.

FIG. 6 illustrates a bifocal mixed reality pass-through camera's partial imaging areas focused at far and near distances, according to an example.

FIG. 7 illustrates how focus may be shifted in a bifocal mixed reality pass-through camera, according to examples.

FIG. 8 illustrates presentation of different focus fields to a user through a bifocal mixed reality pass-through camera, according to an example.

FIG. 9 illustrates a theoretical optical configuration to achieve bifocal focus fields in a mixed reality pass-through camera, according to an example.

FIG. 10 illustrates an optical assembly configuration to implement the theoretical optical configuration of FIG. 6, according to an example.

FIG. 11 illustrates a flow diagram for a method of using a bifocal mixed reality pass-through camera to present different focus fields, according to an example.

FIG. 12A illustrates translational/misalignment and rotation/gaze errors and a visual offset for a user of a waveguide display based near-eye display device, according to examples.

FIG. 12B illustrates how a user's interpupillary distance (IPD) and offsets in relation to the default position may be measured in a fitting/customization process, according to examples.

FIG. 13 illustrates how x, y, and z offsets of the eye centroid relative to the waveguide may change due to slippage of the glasses on the face of the user, according to examples.

FIG. 14 illustrates measured distortion, correction mask, and desired results for different circumstances, according to an example.

FIG. 15 illustrates how a foveated correction threshold may allow for lower overall ratios needed for correction, according to examples.

### DETAILED DESCRIPTION

For simplicity and illustrative purposes, the present application is described by referring mainly to examples thereof. In the following description, numerous specific details are set forth in order to provide a thorough understanding of the present application. It will be readily apparent, however, that the present application may be practiced without limitation to these specific details. In other instances, some methods and structures readily understood by one of ordinary skill in the art have not been described in detail so as not to unnecessarily obscure the present application. As used herein, the terms “a” and “an” are intended to denote at least one of a particular element, the term “includes” means includes but not limited to, the term “including” means including but not limited to, and the term “based on” means based at least in part on.

In waveguide display systems, light from a projector (e.g., a laser light source) couples into a waveguide and couples out of the waveguide being directed to an eyebox of a near-eye display device. While waveguide display systems allow smaller form factors and less complex illumination components, they are also subject to particular challenges. For example, traditional waveguide displays have uniformity issues in both field of view (FOV) and eyebox domains. This is partly because traditional image projection modules have a fixed shape and size of aperture. Therefore, there may be very limited degrees of freedom to control the pupil replication density and size.

In some examples of the present disclosure, an image projection module for waveguide displays with actively controlled variable aperture is described. The controlled (or “variable”) aperture may be on “Fourier domain” of the image, to improve and/or control a uniformity in the field of view (FOV) or eyebox domain. The variable aperture may be implemented by adding another display panel such as a liquid crystal display (LCD), a digital micromirror display (DMD), etc. subsequent to a projection lens in a stack of image panel, projection lens, and waveguide. Degrees of freedom in controlling pupil replication density may include temporal multiplexing of display panel or backlight and the variable aperture itself.

While some advantages and benefits of the present disclosure are apparent, other advantages and benefits may include improvement of pupil replication density in waveguide based display systems while also reducing computational resources for content presentation improvement.

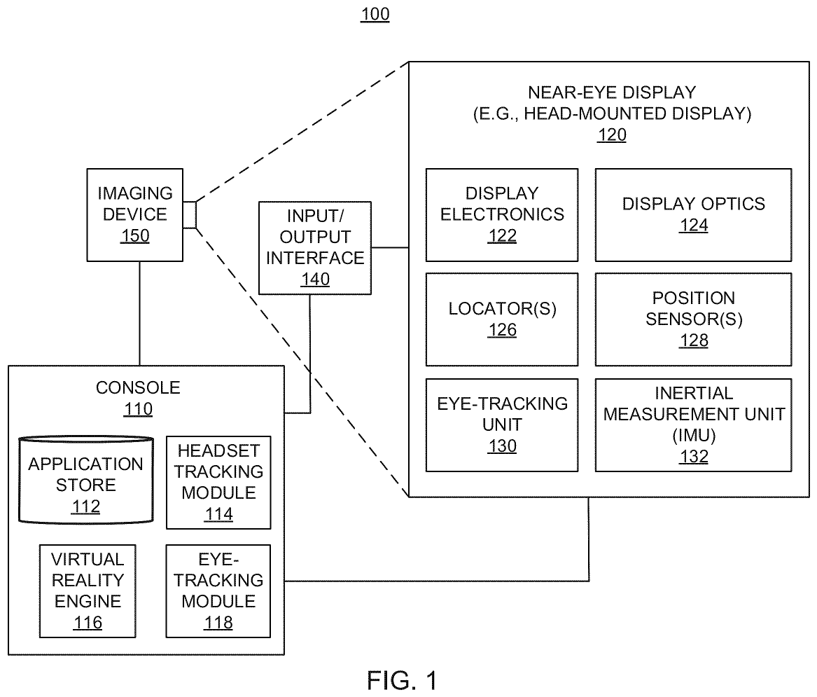

FIG. 1 illustrates a block diagram of an artificial reality system environment 100 including a near-eye display, according to an example. As used herein, a “near-eye display” may refer to a device (e.g., an optical device) that may be in close proximity to a user's eye. As used herein, “artificial reality” may refer to aspects of, among other things, a “metaverse” or an environment of real and virtual elements and may include use of technologies associated with virtual reality (VR), augmented reality (AR), and/or mixed reality (MR). As used herein a “user” may refer to a user or wearer of a “near-eye display.”

As shown in FIG. 1, the artificial reality system environment 100 may include a near-eye display 120, an optional external imaging device 150, and an optional input/output interface 140, each of which may be coupled to a console 110. The console 110 may be optional in some instances as the functions of the console 110 may be integrated into the near-eye display 120. In some examples, the near-eye display 120 may be a head-mounted display (HMD) that presents content to a user.

In some instances, for a near-eye display system, it may generally be desirable to expand an eye box, reduce display haze, improve image quality (e.g., resolution and contrast), reduce physical size, increase power efficiency, and increase or expand field of view (FOV). As used herein, “field of view” (FOV) may refer to an angular range of an image as seen by a user, which is typically measured in degrees as observed by one eye (for a monocular head-mounted display (HMD)) or both eyes (for binocular head-mounted displays (HMDs)). Also, as used herein, an “eye box” may be a two-dimensional box that may be positioned in front of the user's eye from which a displayed image from an image source may be viewed.

In some examples, in a near-eye display system, light from a surrounding environment may traverse a “see-through” region of a waveguide display (e.g., a transparent substrate) to reach a user's eyes. For example, in a near-eye display system, light of projected images may be coupled into a transparent substrate of a waveguide, propagate within the waveguide, and be coupled or directed out of the waveguide at one or more locations to replicate exit pupils and expand the eye box.

In some examples, the near-eye display 120 may include one or more rigid bodies, which may be rigidly or non-rigidly coupled to each other. In some examples, a rigid coupling between rigid bodies may cause the coupled rigid bodies to act as a single rigid entity, while in other examples, a non-rigid coupling between rigid bodies may allow the rigid bodies to move relative to each other.

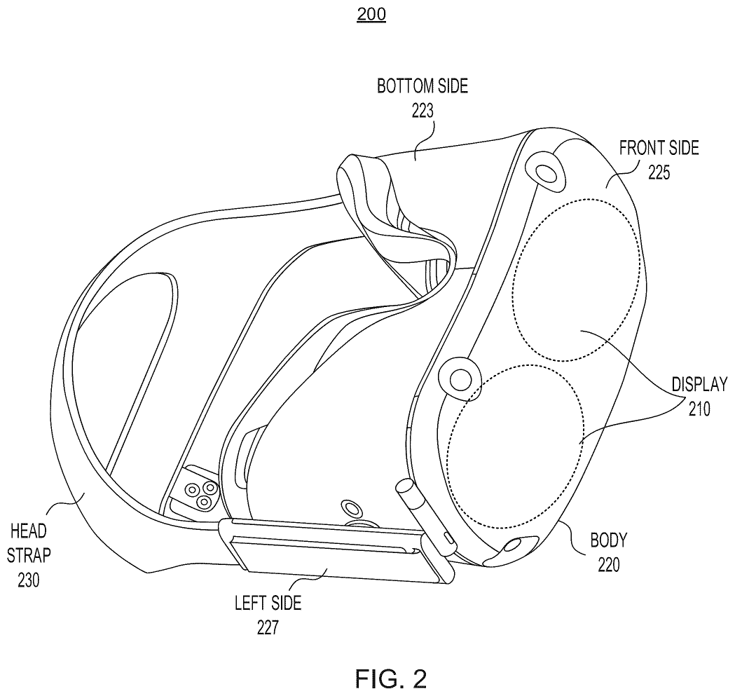

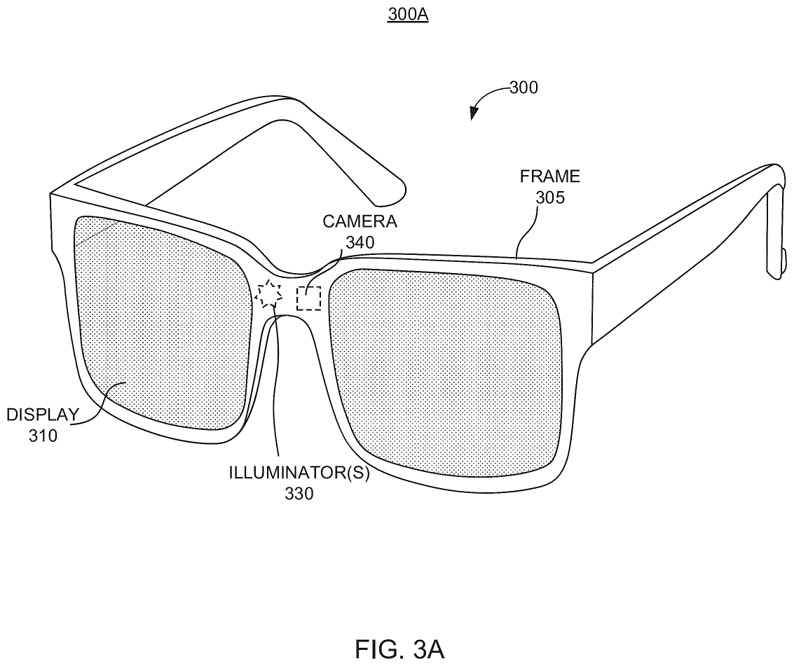

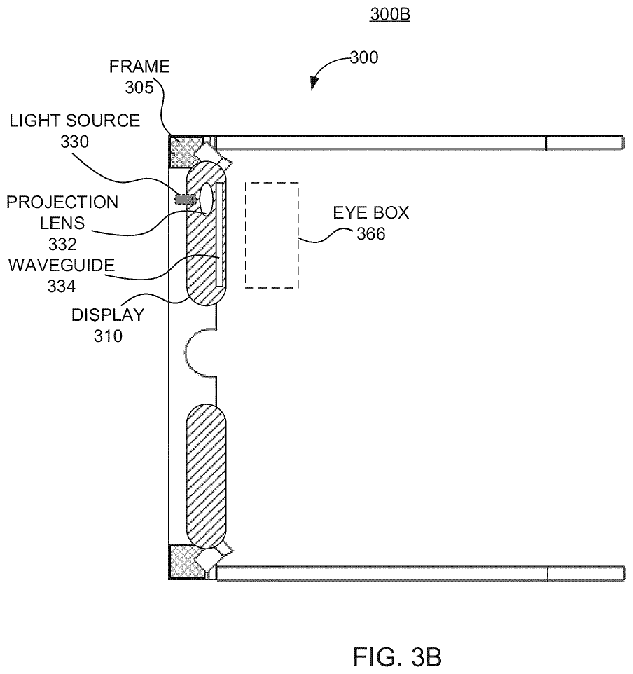

In some examples, the near-eye display 120 may be implemented in any suitable form-factor, including a head-mounted display (HMD), a pair of glasses, or other similar wearable eyewear or device. Examples of the near-eye display 120 are further described below with respect to FIGS. 2 and 3. Additionally, in some examples, the functionality described herein may be used in a head-mounted display (HMD) or headset that may combine images of an environment external to the near-eye display 120 and artificial reality content (e.g., computer-generated images). Therefore, in some examples, the near-eye display 120 may augment images of a physical, real-world environment external to the near-eye display 120 with generated and/or overlaid digital content (e.g., images, video, sound, etc.) to present an augmented reality to a user.

In some examples, the near-eye display 120 may include any number of display electronics 122, display optics 124, and an eye tracking unit 130. In some examples, the near-eye display 120 may also include one or more locators 126, one or more position sensors 128, and an inertial measurement unit (IMU) 132. In some examples, the near-eye display 120 may omit any of the eye tracking unit 130, the one or more locators 126, the one or more position sensors 128, and the inertial measurement unit (IMU) 132, or may include additional elements.

In some examples, the display electronics 122 may display or facilitate the display of images to the user according to data received from, for example, the optional console 110. In some examples, the display electronics 122 may include one or more display panels. In some examples, the display electronics 122 may include any number of pixels to emit light of a predominant color such as red, green, blue, white, or yellow. In some examples, the display electronics 122 may display a three-dimensional (3D) image, e.g., using stereoscopic effects produced by two-dimensional panels, to create a subjective perception of image depth.

In some examples, the near-eye display 120 may include a projector (not shown), which may form an image in angular domain for direct observation by a viewer's eye through a pupil. The projector may employ a controllable light source (e.g., a laser source) and a micro-electromechanical system (MEMS) beam scanner to create a light field from, for example, a collimated light beam. In some examples, the same projector or a different projector may be used to project a fringe pattern on the eye, which may be captured by a camera and analyzed (e.g., by the eye tracking unit 130) to determine a position of the eye (the pupil), a gaze, etc.

In some examples, the display optics 124 may display image content optically (e.g., using optical waveguides and/or couplers) or magnify image light received from the display electronics 122, correct optical errors associated with the image light, and/or present the corrected image light to a user of the near-eye display 120. In some examples, the display optics 124 may include a single optical element or any number of combinations of various optical elements as well as mechanical couplings to maintain relative spacing and orientation of the optical elements in the combination. In some examples, one or more optical elements in the display optics 124 may have an optical coating, such as an anti-reflective coating, a reflective coating, a filtering coating, and/or a combination of different optical coatings.

In some examples, the display optics 124 may also be designed to correct one or more types of optical errors, such as two-dimensional optical errors, three-dimensional optical errors, or any combination thereof. Examples of two-dimensional errors may include barrel distortion, pincushion distortion, longitudinal chromatic aberration, and/or transverse chromatic aberration. Examples of three-dimensional errors may include spherical aberration, chromatic aberration field curvature, and astigmatism.

In some examples, the one or more locators 126 may be objects located in specific positions relative to one another and relative to a reference point on the near-eye display 120. In some examples, the optional console 110 may identify the one or more locators 126 in images captured by the optional external imaging device 150 to determine the artificial reality headset's position, orientation, or both. The one or more locators 126 may each be a light-emitting diode (LED), a corner cube reflector, a reflective marker, a type of light source that contrasts with an environment in which the near-eye display 120 operates, or any combination thereof.

In some examples, the external imaging device 150 may include one or more cameras, one or more video cameras, any other device capable of capturing images including the one or more locators 126, or any combination thereof. The optional external imaging device 150 may be configured to detect light emitted or reflected from the one or more locators 126 in a field of view of the optional external imaging device 150.

In some examples, the one or more position sensors 128 may generate one or more measurement signals in response to motion of the near-eye display 120. Examples of the one or more position sensors 128 may include any number of accelerometers, gyroscopes, magnetometers, and/or other motion-detecting or error-correcting sensors, or any combination thereof.

In some examples, the inertial measurement unit (IMU) 132 may be an electronic device that generates fast calibration data based on measurement signals received from the one or more position sensors 128. The one or more position sensors 128 may be located external to the inertial measurement unit (IMU) 132, internal to the inertial measurement unit (IMU) 132, or any combination thereof. Based on the one or more measurement signals from the one or more position sensors 128, the inertial measurement unit (IMU) 132 may generate fast calibration data indicating an estimated position of the near-eye display 120 that may be relative to an initial position of the near-eye display 120. For example, the inertial measurement unit (IMU) 132 may integrate measurement signals received from accelerometers over time to estimate a velocity vector and integrate the velocity vector over time to determine an estimated position of a reference point on the near-eye display 120. Alternatively, the inertial measurement unit (IMU) 132 may provide the sampled measurement signals to the optional console 110, which may determine the fast calibration data.

The eye tracking unit 130 may include one or more eye tracking systems. As used herein, “eye tracking” may refer to determining an eye's position or relative position, including orientation, location, and/or gaze of a user's eye. In some examples, an eye tracking system may include an imaging system that captures one or more images of an eye and may optionally include a light emitter, which may generate light (e.g., a fringe pattern) that is directed to an eye such that light reflected by the eye may be captured by the imaging system (e.g., a camera). The fringe image may be projected onto the eye by a projector. A structured image may also be projected onto the eye by a micro-electromechanical system (MEMS) based scanner reflecting light (e.g., laser light) from a light source. In other examples, the eye tracking unit 130 may capture reflected radio waves emitted by a miniature radar unit. These data associated with the eye may be used to determine or predict eye position, orientation, movement, location, and/or gaze.

In some examples, the near-eye display 120 may use the orientation of the eye to introduce depth cues (e.g., blur image outside of the user's main line of sight), collect heuristics on the user interaction in the virtual reality (VR) media (e.g., time spent on any particular subject, object, or frame as a function of exposed stimuli), some other functions that are based in part on the orientation of at least one of the user's eyes, or any combination thereof. In some examples, because the orientation may be determined for both eyes of the user, the eye tracking unit 130 may be able to determine where the user is looking or predict any user patterns, etc.

In some examples, the input/output interface 140 may be a device that allows a user to send action requests to the optional console 110. As used herein, an “action request” may be a request to perform a particular action. For example, an action request may be to start or to end an application or to perform a particular action within the application. The input/output interface 140 may include one or more input devices. Example input devices may include a keyboard, a mouse, a game controller, a glove, a button, a touch screen, or any other suitable device for receiving action requests and communicating the received action requests to the optional console 110. In some examples, an action request received by the input/output interface 140 may be communicated to the optional console 110, which may perform an action corresponding to the requested action.

In some examples, the optional console 110 may provide content to the near-eye display 120 for presentation to the user in accordance with information received from one or more of external imaging device 150, the near-eye display 120, and the input/output interface 140. For example, in the example shown in FIG. 1, the optional console 110 may include an application store 112, a headset tracking module 114, a virtual reality engine 116, and an eye tracking module 118. Some examples of the optional console 110 may include different or additional modules than those described in conjunction with FIG. 1. Functions further described below may be distributed among components of the optional console 110 in a different manner than is described here.

In some examples, the optional console 110 may include a processor and a non-transitory computer-readable storage medium storing instructions executable by the processor. The processor may include multiple processing units executing instructions in parallel. The non-transitory computer-readable storage medium may be any memory, such as a hard disk drive, a removable memory, or a solid-state drive (e.g., flash memory or dynamic random access memory (DRAM)). In some examples, the modules of the optional console 110 described in conjunction with FIG. 1 may be encoded as instructions in the non-transitory computer-readable storage medium that, when executed by the processor, cause the processor to perform the functions further described below. It should be appreciated that the optional console 110 may or may not be needed or the optional console 110 may be integrated with or separate from the near-eye display 120.

In some examples, the application store 112 may store one or more applications for execution by the optional console 110. An application may include a group of instructions that, when executed by a processor, generates content for presentation to the user. Examples of the applications may include gaming applications, conferencing applications, video playback application, or other suitable applications.

In some examples, the headset tracking module 114 may track movements of the near-eye display 120 using slow calibration information from the external imaging device 150. For example, the headset tracking module 114 may determine positions of a reference point of the near-eye display 120 using observed locators from the slow calibration information and a model of the near-eye display 120. Additionally, in some examples, the headset tracking module 114 may use portions of the fast calibration information, the slow calibration information, or any combination thereof, to predict a future location of the near-eye display 120. In some examples, the headset tracking module 114 may provide the estimated or predicted future position of the near-eye display 120 to the virtual reality engine 116.

In some examples, the virtual reality engine 116 may execute applications within the artificial reality system environment 100 and receive position information of the near-eye display 120, acceleration information of the near-eye display 120, velocity information of the near-eye display 120, predicted future positions of the near-eye display 120, or any combination thereof from the headset tracking module 114. In some examples, the virtual reality engine 116 may also receive estimated eye position and orientation information from the eye tracking module 118. Based on the received information, the virtual reality engine 116 may determine content to provide to the near-eye display 120 for presentation to the user.

In some examples, the eye tracking module 118, which may be implemented as a processor, may receive eye tracking data from the eye tracking unit 130 and determine the position of the user's eye based on the eye tracking data. In some examples, the position of the eye may include an eye's orientation, location, or both relative to the near-eye display 120 or any element thereof. So, in these examples, because the eye's axes of rotation change as a function of the eye's location in its socket, determining the eye's location in its socket may allow the eye tracking module 118 to more accurately determine the eye's orientation.

In some examples, a location of a projector of a display system may be adjusted to enable any number of design modifications. For example, in some instances, a projector may be located in front of a viewer's eye (i.e., “front-mounted” placement). In a front-mounted placement, in some examples, a projector of a display system may be located away from a user's eyes (i.e., “world-side”). In some examples, a head-mounted display (HMD) device may utilize a front-mounted placement to propagate light towards a user's eye(s) to project an image.

FIG. 2 illustrates a perspective view of a near-eye display in the form of a head-mounted display (HMD) device 200, according to an example. In some examples, the head-mounted device (HMD) device 200 may be a part of a virtual reality (VR) system, an augmented reality (AR) system, a mixed reality (MR) system, another system that uses displays or wearables, or any combination thereof. In some examples, the head-mounted display (HMD) device 200 may include a body 220 and a head strap 230.

FIG. 2 shows a bottom side 223, a front side 225, and a left side 227 of the body 220 in the perspective view. In some examples, the head strap 230 may have an adjustable or extendible length. In particular, in some examples, there may be a sufficient space between the body 220 and the head strap 230 of the head-mounted display (HMD) device 200 for allowing a user to mount the head-mounted display (HMD) device 200 onto the user's head. For example, the length of the head strap 230 may be adjustable to accommodate a range of user head sizes. In some examples, the head-mounted display (HMD) device 200 may include additional, fewer, and/or different components.

In some examples, the head-mounted display (HMD) device 200 may present, to a user, media or other digital content including virtual and/or augmented views of a physical, real-world environment with computer-generated elements. Examples of the media or digital content presented by the head-mounted display (HMD) device 200 may include images (e.g., two-dimensional (2D) or three-dimensional (3D) images), videos (e.g., 2D or 3D videos), audio, or any combination thereof. In some examples, the images and videos may be presented to each eye of a user by one or more display assemblies (not shown in FIG. 2) enclosed in the body 220 of the head-mounted display (HMD) device 200.

In some examples, the head-mounted display (HMD) device 200 may include various sensors (not shown), such as depth sensors, motion sensors, position sensors, and/or eye tracking sensors. Some of these sensors may use any number of structured or unstructured light patterns for sensing purposes. In some examples, the head-mounted display (HMD) device 200 may include an input/output interface 140 for communicating with a console 110, as described with respect to FIG. 1. In some examples, the head-mounted display (HMD) device 200 may include a virtual reality engine (not shown), but similar to the virtual reality engine 116 described with respect to FIG. 1, that may execute applications within the head-mounted display (HMD) device 200 and receive depth information, position information, acceleration information, velocity information, predicted future positions, or any combination thereof of the head-mounted display (HMD) device 200 from the various sensors.

In some examples, the information received by the virtual reality engine 116 may be used for producing a signal (e.g., display instructions) to the one or more display assemblies. In some examples, the head-mounted display (HMD) device 200 may include locators (not shown), but similar to the locators 126 described in FIG. 1, which may be located in fixed positions on the body 220 of the head-mounted display (HMD) device 200 relative to one another and relative to a reference point. Each of the locators may emit light that is detectable by an external imaging device. This may be useful for the purposes of head tracking or other movement/orientation. It should be appreciated that other elements or components may also be used in addition or in lieu of such locators.

It should be appreciated that in some examples, a projector mounted in a display system may be placed near and/or closer to a user's eye (i.e., “eye-side”). In some examples, and as discussed herein, a projector for a display system shaped like eyeglasses may be mounted or positioned in a temple arm (i.e., a top far corner of a lens side) of the eyeglasses. It should be appreciated that, in some instances, utilizing a back-mounted projector placement may help to reduce size or bulkiness of any required housing required for a display system, which may also result in a significant improvement in user experience for a user. In some examples, the display 210 may include a waveguide. To mitigate non-uniformity of pupil replication, the display 210 may include actively controlled variable aperture as described herein. The controlled (or “variable”) aperture may be on “Fourier domain” of the image, to improve and/or control a uniformity in the field of view (FOV) or eyebox domain. The variable aperture may be implemented by adding another display panel such as a liquid crystal display (LCD), a digital micromirror display (DMD), etc. subsequent to a projection lens in a stack of image panel, projection lens, and waveguide. Degrees of freedom in controlling pupil replication density may include temporal multiplexing of display panel or backlight and the variable aperture itself.

FIG. 3A is a perspective view 300A of a near-eye display 300 in the form of a pair of glasses (or other similar eyewear), according to an example. In some examples, the near-eye display 300 may be a specific example of near-eye display 120 of FIG. 1 and may be configured to operate as a virtual reality display, an augmented reality (AR) display, and/or a mixed reality (MR) display.

In some examples, the near-eye display 300 may include a frame 305 and a display 310. In some examples, the display 310 may be configured to present media or other content to a user. In some examples, the display 310 may include display electronics and/or display optics, similar to components described with respect to FIGS. 1-2. For example, as described above with respect to the near-eye display 120 of FIG. 1, the display 310 may include a liquid crystal display (LCD) display panel, a light-emitting diode (LED) display panel, or an optical display panel (e.g., a waveguide display assembly). In some examples, the display 310 may also include variable aperture, which may be implemented by adding another display panel such as a liquid crystal display (LCD), a digital micromirror display (DMD), etc. subsequent to a projection lens in a stack of image panel, projection lens, and waveguide.

In some examples, the near-eye display 300 may further include various sensors on or within a frame 305. In some examples, the various sensors may include any number of depth sensors, motion sensors, position sensors, inertial sensors, and/or ambient light sensors, as shown. In some examples, the various sensors may include any number of image sensors configured to generate image data representing different fields of views in one or more different directions. In some examples, the various sensors may be used as input devices to control or influence the displayed content of the near-eye display, and/or to provide an interactive virtual reality (VR), augmented reality (AR), and/or mixed reality (MR) experience to a user of the near-eye display 300. In some examples, the various sensors may also be used for stereoscopic imaging or other similar applications.

In some examples, the near-eye display 300 may further include one or more illuminators 330 to project light into a physical environment. The projected light may be associated with different frequency bands (e.g., visible light, infra-red light, ultra-violet light, etc.), and may serve various purposes. In some examples, the one or more illuminator(s) 330 may be used as locators, such as the one or more locators 126 described above with respect to FIGS. 1-2.

In some examples, the near-eye display 300 may also include a camera 340 or other image capture unit. The camera 340, for instance, may capture images of the physical environment in the field of view. In some instances, the captured images may be processed, for example, by a virtual reality engine (e.g., the virtual reality engine 116 of FIG. 1) to add virtual objects to the captured images or modify physical objects in the captured images, and the processed images may be displayed to the user by the display 310 for augmented reality (AR) and/or mixed reality (MR) applications.

FIG. 3B is a top view 300B of a near-eye display 300 in the form of a pair of glasses (or other similar eyewear), according to an example. In some examples, the near-eye display 300 may include a frame 305 having a form factor of a pair of eyeglasses. The frame 305 supports, for each eye: a display 310 to present content to an eye box 366. The display 310 may include a pupil-replicating waveguide 334 to receive the fan of light beams from a light source 330 (image panel) and provide multiple laterally offset parallel copies of each beam of the fan of light beams, thereby extending a projected image over the eye box 366. The display 310 may further include a projection lens 332 between the light source 330 and the waveguide 334.

In some examples, the pupil-replicating waveguide may be transparent or translucent to enable the user to view the outside world together with the images projected into each eye and superimposed with the outside world view. The images projected into each eye may include objects disposed with a simulated parallax, so as to appear immersed into the real-world view.

In some examples, the image processing and eye position/orientation determination functions may be performed by a central controller, not shown, of the near-eye display 300. The central controller may also provide control signals to the display 310 to generate the images to be displayed to the user, depending on the determined eye positions, eye orientations, gaze directions, eyes vergence, etc.

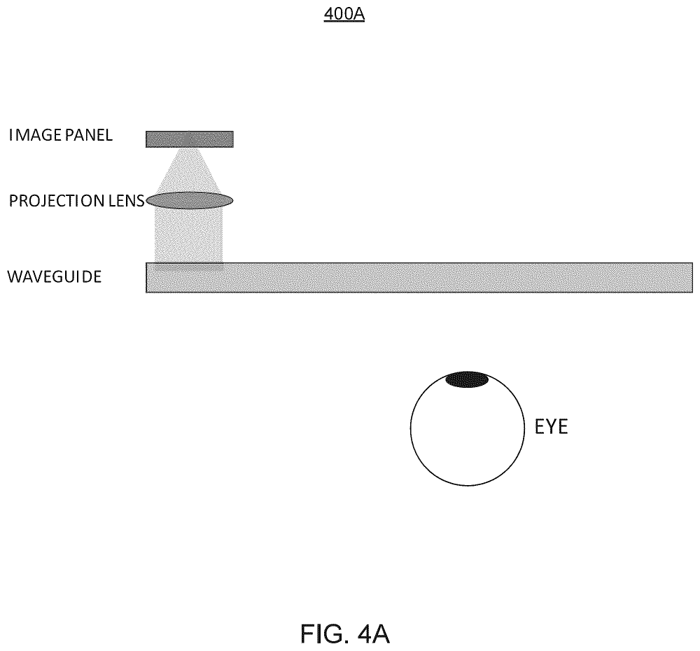

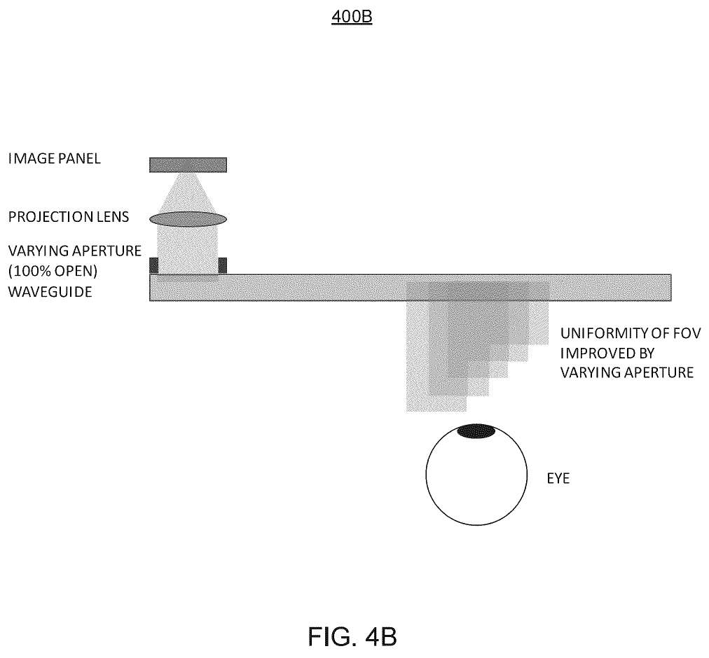

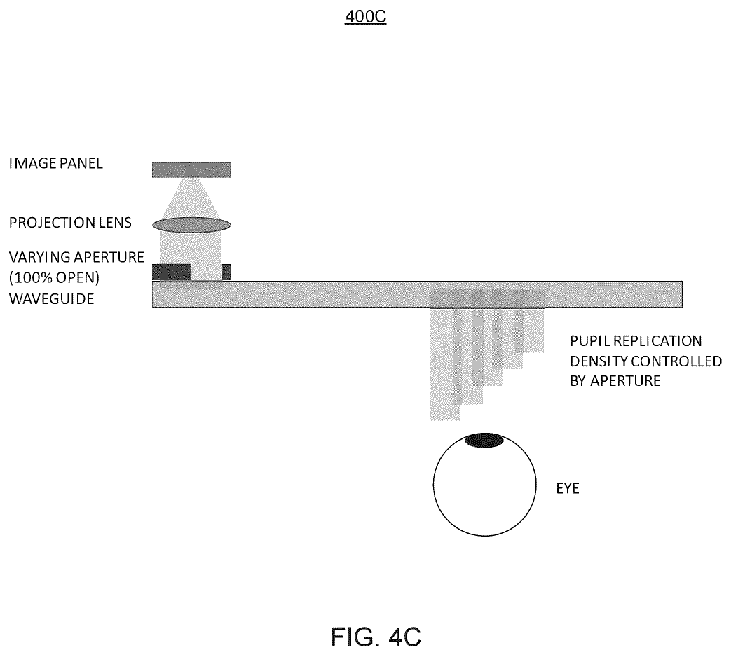

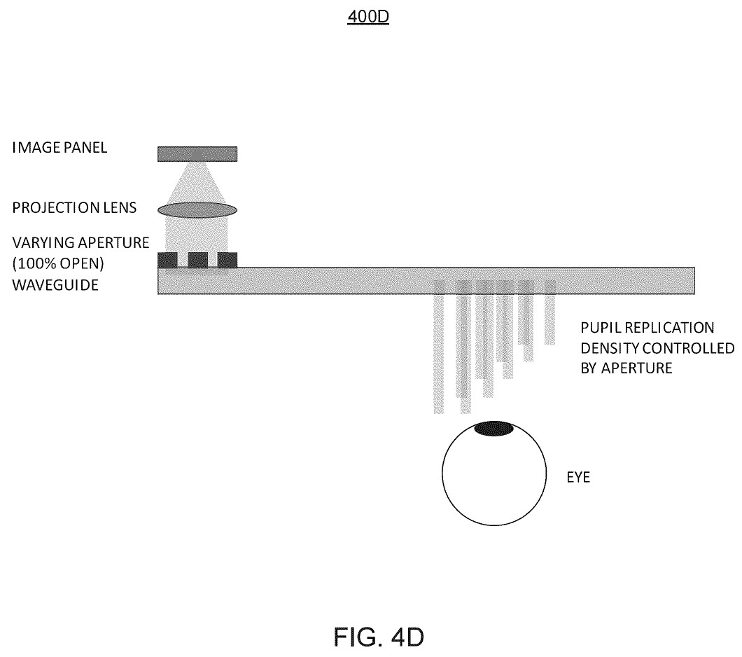

FIG. 4A illustrates a waveguide display projecting content from an image panel to an eye. Diagram 400A shows an example display stack with an image panel (light source), a projection lens, and a waveguide to project the received images onto the eye. In some examples, the stack may also include a backlight behind the image panel (not shown).

As discussed herein, the pupil-replicating waveguide may receive a fan of light beams from the image panel through the projection lens and provide multiple laterally offset parallel copies of each beam of the fan of light beams into the pupil of the eye, thereby extending a projected image over the eye box. In some cases, the pupil-replicating waveguide may be transparent or translucent to enable the user to view the outside world together with the images projected into each eye and superimposed with the outside world view. The images projected into each eye may include objects disposed with a simulated parallax, so as to appear immersed into the real-world view. Without further improvements, the waveguide based display may have non-uniformity in both field of view (FOV) and eye box domains due to fixed shape and size of the waveguide intake aperture.

FIGS. 4B through 4D illustrate various configurations of a variable aperture implemented in a waveguide display projecting content from an image panel to an eye, according to examples.

Diagram 400B of FIG. 4B shows a variable (controlled) aperture between the projection lens and the waveguide in 100% open state. By controlling the exit pupil aperture shape and size of the projector (or entrance pupil aperture of the waveguide), the uniformity of the waveguide display in field of view (FOV) and eye box domains may be improved.

Diagram 400C of FIG. 4C shows the variable (controlled) aperture between the projection lens and the waveguide in approximately 50% open state. A density change in pupil replication corresponding to the aperture opening is also shown. Thus, the aperture may be, in some examples, opened linearly at varying percentages allowing pupil replication density to be controlled accordingly.

Diagram 400D of FIG. 4D shows a different configuration of the variable aperture, where the instead of linear opening, the aperture may be opened in an arbitrary form (e.g., circular, holes, etc.). The arbitrary opening may also provide pupil replication density control.

Accordingly, pupil replication density may be controlled at the eye box domain through a variable aperture at the entrance opening of the waveguide. The variable aperture may be implemented using TFT, LCOS or DMD. If a reflection type modulator is used, projection module configuration may change accordingly.

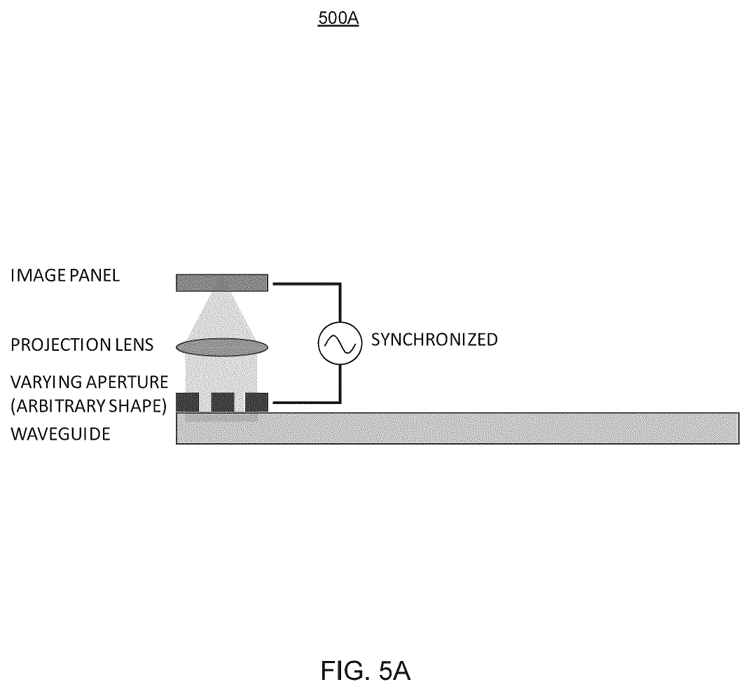

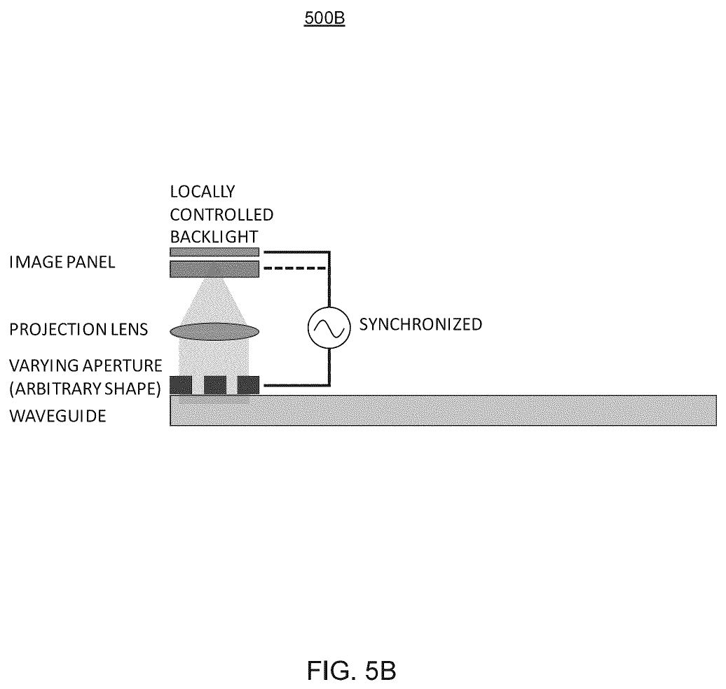

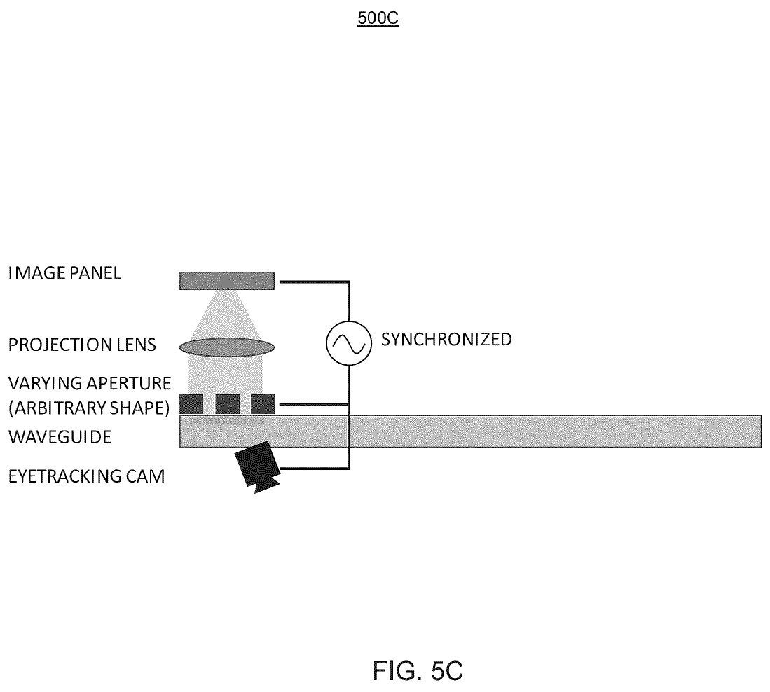

FIGS. 5A through 5C illustrate synchronization of a variable aperture implemented in a waveguide display projecting content from an image panel to an eye with the image panel or a controlled backlight, according to examples.

Diagram 500A of FIG. 5A shows a configuration, where the variable aperture is controlled through synchronization by the image panel. If both image panel and varying aperture can support high frame rate, they may be synchronized, and the uniformity and the resolution may be optimized, both at the eye box and the field of view (FOV) domain per FOV.

If the image panel does not support high frame rate, a locally controlled backlight may be used to achieve similar result to the image panel-variable aperture synchronization. Furthermore, the backlight and the image panel may both be used together with the variable aperture for even more improvement in the uniformity and the resolution in some examples as shown in diagram 500B of FIG. 5B.

Diagram 500C of FIG. 5C shows yet another configuration, where an eye tracking camera may be used to optimize variable aperture-image panel synchronization through eye tracking, which may provide user's pupil size and/or location information.

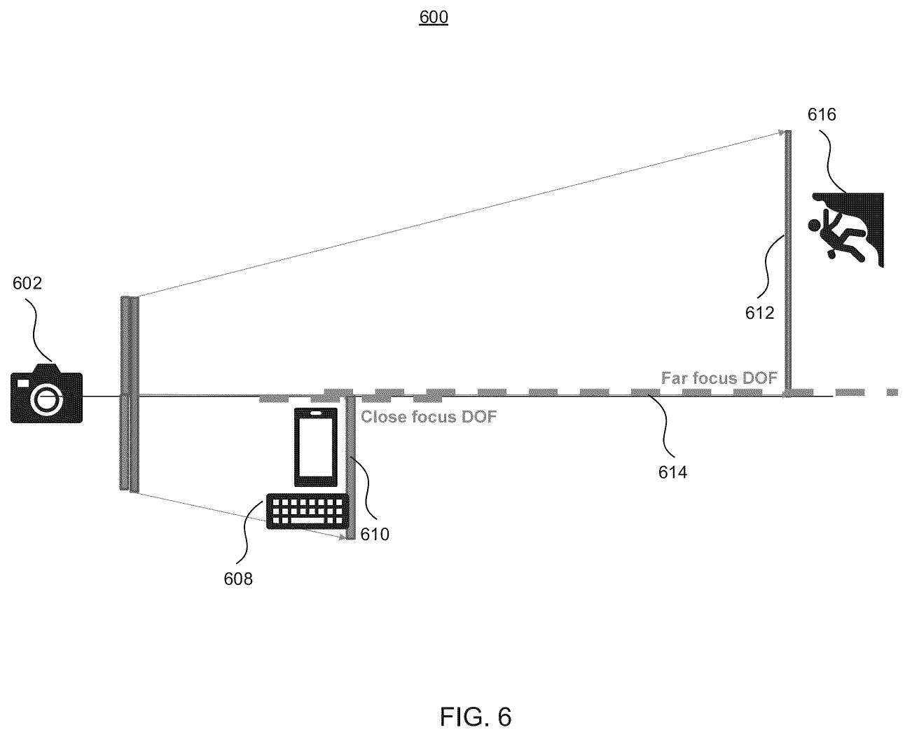

FIG. 6 illustrates a bifocal mixed reality pass-through camera's partial imaging areas focused at far and near distances, according to an example. Diagram 600 shows a camera device 602 with a far distance focus DOF 604 to capture an object 616 at the far distance and a near distance focus DOF 606 to capture an object 608 at the near distance.

Mixed reality (MR) pass-through cameras allow a user to see their surrounding environment, while also being presented with virtual reality content augmented on the actual environment. Such camera devices need to provide an image clear enough to recognize people in the far distance, for example, and screen text readable at close distance. Some approaches for such clarity may include using a camera sensor with more pixels to increase image resolution, using a sensor with bigger pixels, and/or lower F/# to improve low light image performance. However, fixed focus lens design cannot cover such large required depth of field with sufficiently clear image. Thus, fixed focus camera devices have a trade-off between resolution, DOF, and low light performance.

Another approach to focus change in camera devices is gaze driven autofocus pass-through camera configuration, which work with an eye tracking camera to locate which object eyes are looking at, then autofocus on that object. The autofocus technologies include voice coil motor (VCM) or varifocal lens. These approaches, however, usually consume more power for autofocus and image processing, have bigger camera package size, need to be synchronized (if two cameras are used), and have reliability/manufacturing challenges.

The far distance focus DOF 604 and the near distance focus DOF 606 of the camera device 602 in diagram 600 are fixed focus fields. As the two fixed focus fields are achieved by stationary optics (and not by motorized or electronic components), power consumption, reliability, etc. challenges are mitigated.

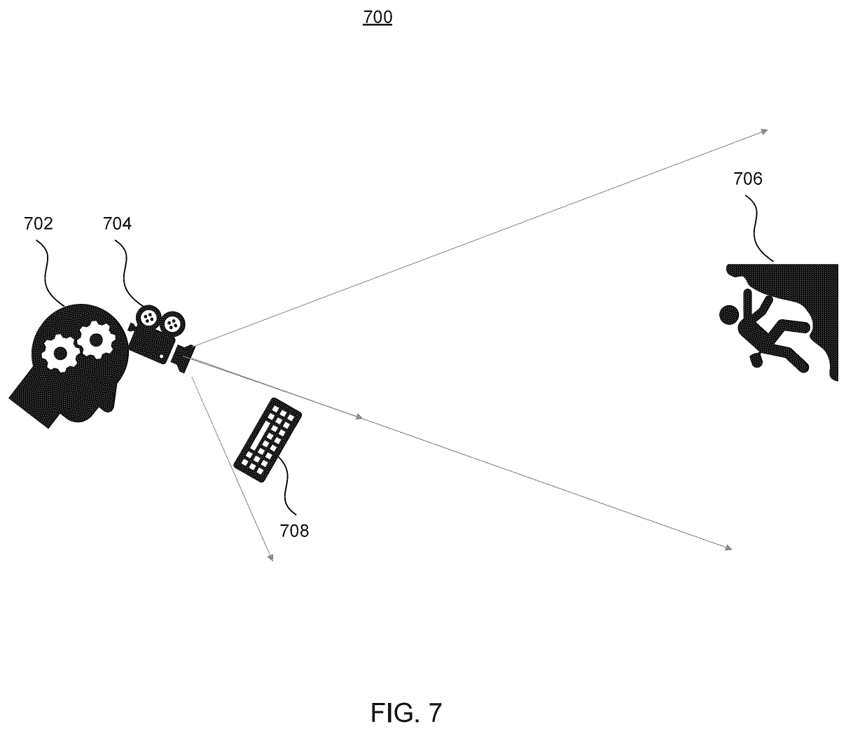

FIG. 7 illustrates how focus may be shifted in a bifocal mixed reality pass-through camera, according to examples. Diagram 700 shows a camera device 704 on a user's head 702 with two distinct focus DOFs, far distance focus field to capture object 706 at the far distance and near distance focus field to capture object 708 at the near distance.

People tend to look up when looking at far distance and down when looking at near distance such as looking at a computer screen or reading. Thus, arranging the fixed focus fields of the camera device 704 such that the far distance focus DOF is above the near distance focus DOF may allow a user to naturally switch between the two focus fields: tilt the head up for far distance, tilt the head down for near distance.

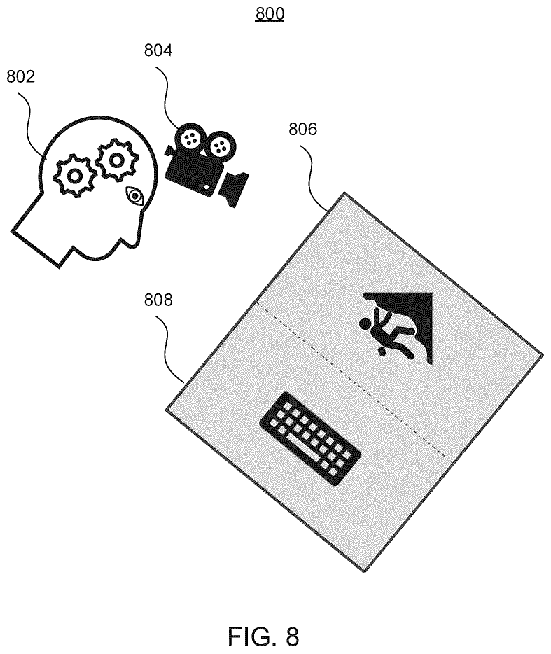

FIG. 8 illustrates presentation of different focus fields to a user through a bifocal mixed reality pass-through camera, according to an example. Diagram 800 shows a camera device 804 on a head 802 of a user (for example, as part of a head-mounted display (HMD) device) with the user seeing far distance focus DOF 806 and near distance focus DOF 808 vertically arranged. In some examples, one of the two focus DOFs may be selected based on the user's head tilt and presented to the user's eyes.

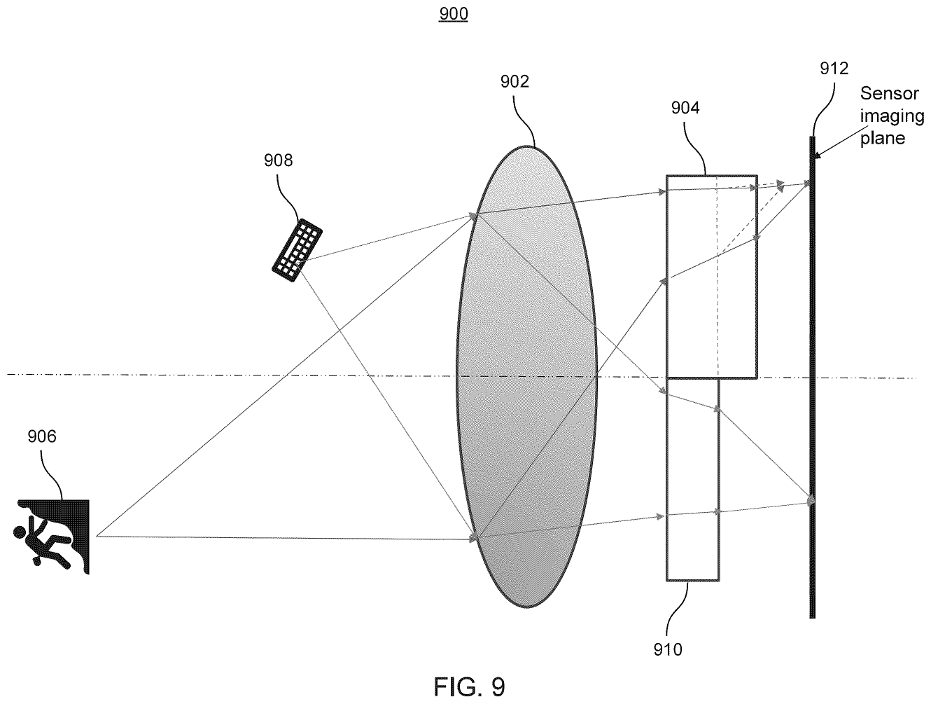

FIG. 9 illustrates a theoretical optical configuration to achieve bifocal focus fields in a mixed reality pass-through camera, according to an example. Diagram 900 shows an optical lens 902 arranged to direct light from a near distance object 908 to a thinner portion 910 of an IRCF and light from a far distance object 906 toward a thicker portion 904 of the IRCF. The lights from the objects are then provided onto respective portions of the camera sensor 912 on the same imaging plane.

In some examples, the optical lens's configuration may allow the IRCF portions with different thicknesses to increase an optical path for the object 906 at the far distance (additional IRCF material with higher refractive index than air due to the increased thickness) such that far and near objects are imaged at the same image plane (camera sensor 912) making their image quality both clear without further electronic processing or adjustment of positions of any of the components. In some implementations, refractive index of the IRCF may be about 1.52, and a thickness range of the IRCF may be in a range from about 0.25 mm to about 0.5 mm.

Accordingly, two objects at different distances may be viewed with same clarity by one camera with only half (or less) envelope space compared to using two separate cameras. Each image may have as good image resolution, contrast, and other image qualities compared to using two individual cameras. Furthermore, the camera does not need to have moving elements (for switching distances). Cost and complexity of a host device may also be lower by reduction of the number of cameras.

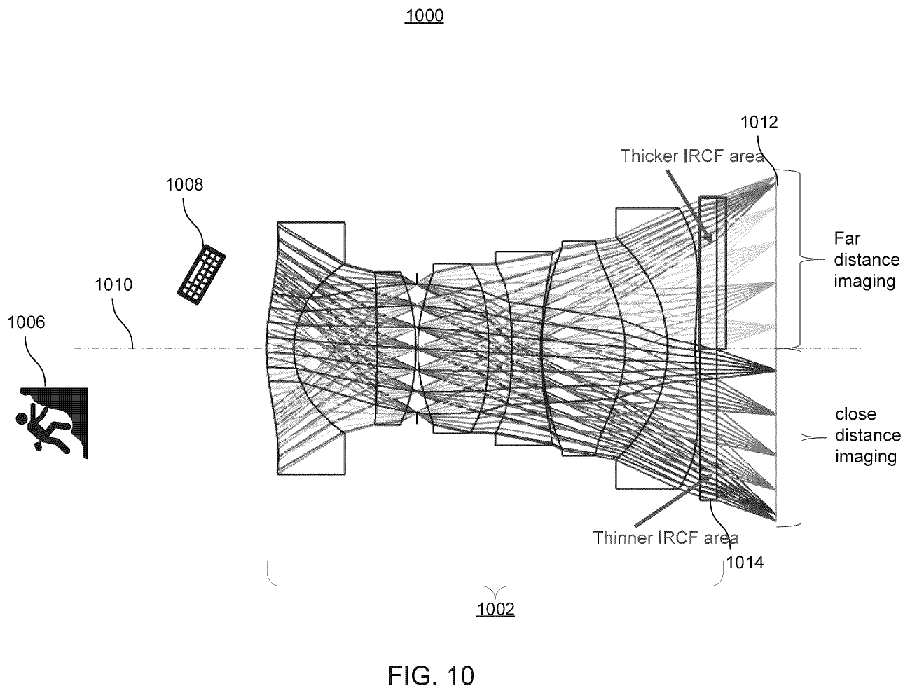

FIG. 10 illustrates an optical assembly configuration to implement the theoretical optical configuration of FIG. 9, according to an example. Diagram 1000 shows an optical assembly 1002 if a plurality of optical lenses (and other elements) aligned along their orthogonal axis 1010 and providing images of a far distance object 1006 and a near distance object 1008 onto a camera sensor 1012.

In some examples, an infrared cut-off filter (IRCF) 1014 may be present between the optical assembly 1002 and the camera sensor 1012. By selecting different thicknesses for two portions of the IRCF 1014 the far and near distance images may be provided to two portions of the camera sensor 1012. For example, an upper portion of the IRCF 1014 may be thicker compared to the lower portion. The upper portion may provide far distance image to the camera sensor 1012, and the lower portion may provide near distance image to the camera sensor 1012. The object at far distance has shorter image distance than object at near distance. By increasing the local IRCF thickness, optical path may be increased (because IRCF material has higher refractive index than air) for the object at far distance such that far and near objects may be imaged at the same image plane.

In some examples, the optical assembly 1002 may include a number of negative and/or positive optical power lenses. In practical implementations, the negative and/or optical power lenses may change a diagonal field of view (DFOV) of the camera device, provide imaging power, correct spherical and chromatic aberrations, and/or correct distortion and other remaining aberrations. The optical errors and aberrations may include two-dimensional optical errors, three-dimensional optical errors, or any combination thereof. Examples of two-dimensional errors may include barrel distortion, pincushion distortion, longitudinal chromatic aberration, and/or transverse chromatic aberration. Examples of three-dimensional errors may include spherical aberration, chromatic aberration field curvature, and astigmatism.

The optical lenses in the optical assembly may be any suitable optical lens such as concave, plano-concave, plano-convex, concave-convex, and others. The optical assembly 1002 may include a single optical element or any number of combinations of various optical elements as well as mechanical couplings to maintain relative spacing and orientation of the optical elements in the combination.

In some examples, one or more optical elements may have an optical coating, such as an anti-reflective coating, a reflective coating, a filtering coating, and/or a combination of different optical coatings. Furthermore, other optical elements such as filters, polarizers, and comparable elements may also be included in the optical assembly 1002.

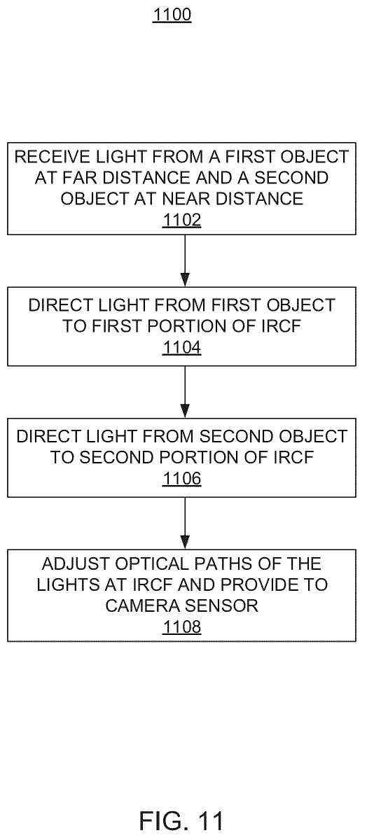

FIG. 11 illustrates a flow diagram for a method of using a bifocal mixed reality pass-through camera to present different focus fields, according to an example. The method 1100 is provided by way of example, as there may be a variety of ways to carry out the method described herein. Although the method 1100 is primarily described as being performed by the components of FIG. 10, the method 1100 may be executed or otherwise performed by one or more processing components of another system or a combination of systems. Each block shown in FIG. 11 may further represent one or more processes, methods, or subroutines, and one or more of the blocks (e.g., the selection process) may include machine readable instructions stored on a non-transitory computer readable medium and executed by a processor or other type of processing circuit to perform one or more operations described herein.

At block 1102, light may be received from a first object that is at a far distance to a camera and a second object that is at a near distance to the camera. The light from the first object may be directed by an optical lens or an optical assembly toward a first portion of an IRCF that is thicker at block 1104, whereas the light from the second object may be directed by the optical lens or the optical assembly toward a second portion of the IRCF that is thinner at block 1106.

At block 1108, the portions of the IRCF with different thicknesses may adjust optical paths from the first and second objects such that the images of the objects fall onto the same imaging plane on the camera sensor. Accordingly, both objects may be captured (and displayed to a user) with same clarity, resolution, etc.

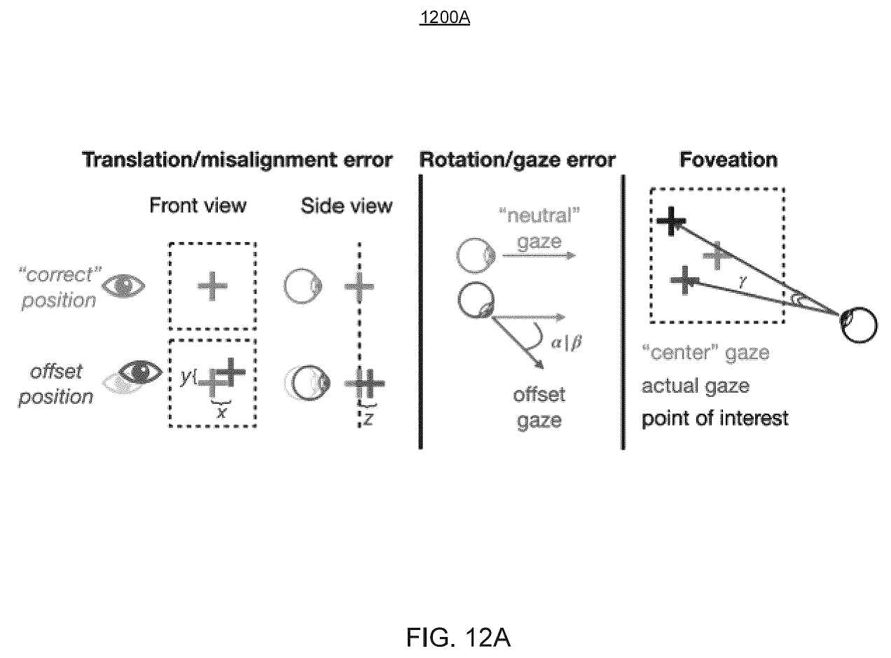

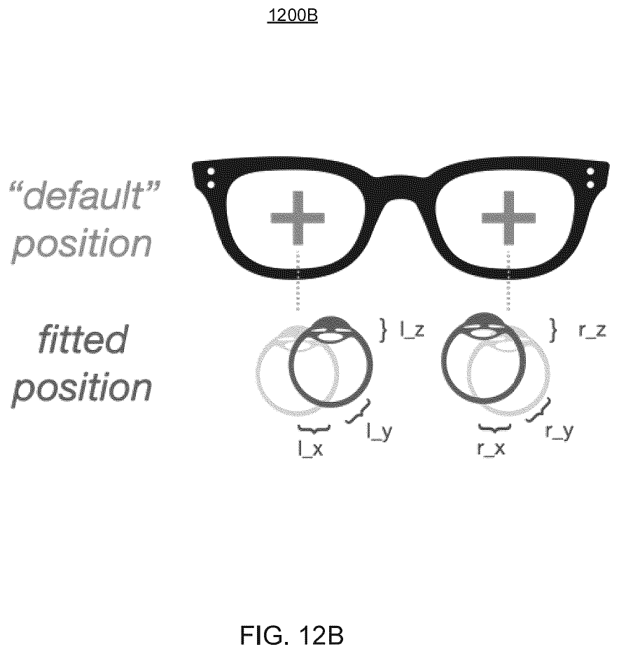

FIG. 12A illustrates translational/misalignment and rotation/gaze errors and a visual offset for a user of a waveguide display based near-eye display device, according to examples. Diagram 1200A shows translational offset (parameterized using x, y, and z variables) on the left. This error stems from misalignment of the eye with a center of the eyebox. A rotation/gaze misalignment (shown in the center) appears when the eye is not looking straight ahead, but is rotated in relation to the display, for example, due to normal eye motion. The rotation/gaze misalignment may be parameterized in three dimensions using the α and β values in degrees. A visual offset for the user is presented on the right side. When the user focuses (foveates) on the magenta point, a certain point of interest marked in black is located at γ degrees of eccentricity.

As mentioned herein, waveguides produce color non-uniformity artifacts, which may vary in severity based on the position of the eye. Dynamic correction (DUC), a technique to mitigate such artifacts, is based on a N×N point measurement evaluating the severity of the distortion, which is then corrected based on a DE color metric KPI. As shown in diagram 1200A, this means translational and rotational error are treated using only three parameters, x, y, and z. In some examples, an additional aspect is provided to these approaches—taking into account gaze-based eccentricity information.

Accordingly, the metrics may be relaxed for the DUC corrections by taking aspects of the human visual system, including the deterioration of color vision outside the fovea, into account. Given this reduction in color sensitivity in the periphery, the KPIs may be relaxed while maintaining a desired degree of perceptual fidelity. Ideally, x, y, z, α, and β should each be characterized, and the eccentricity of a certain point of interest in relation to user gaze position may also be accounted for when setting the KPIs.

FIG. 12B illustrates how a user's interpupillary distance (IPD) and offsets in relation to the default position may be measured in a fitting/customization process, according to examples. Diagram 1200B shows a user's interpupillary distance (IPD) and offsets in relation to a default position, and how they may be measured in a fitting/customization procedure. The IPD, offset information may be leveraged to extract x, y, z, a, and β values from an eye tracking system, for example.

In some examples, users may undergo a fitment stage, which aims to customize their glasses to them. During this step, the users' nominal interpupillary distance (IPD) and eye relief may be obtained providing information about the users x, y, and z location and the centroid of the eyeball in relation to the waveguide as shown in the diagram 1200B. Based on the obtained information a gaze vector may be extracted for each eye position, which in turn may provide a zone mask for correction.

The complexity of getting an accurate color non uniformity profile stems from challenges in modeling an artifact that depends on eye position, gaze vector, pupil distance to the waveguide, and pupil size. A fully comprehensive model may require a complex light field like approach, which may not be computationally viable in a glasses form factor near-eye display device. To simplify the modeling approach, leveraging of all perceptual aspects that may allow relaxation of the required complexity may be applied. Thereby, the computational load and/or a number of interpolation operations may be reduced, or a target accuracy of correction may be increased.

In some examples, light field data may be collected during manufacturing to calibrate and measure the waveguide. After fitting for an individual, the light field data may be used to compute appropriate down-selected correction coefficients in a custom fashion for that particular user. These correction profiles may be pre-loaded and associated with the user's profile.

Given a fixed IPD value from fitment, the possible slippage offsets may be more limited than in the general case. A set of coefficients may also be stored and loaded for situations where there is slippage from the nominal position. Correction tables for a full light field style approach may be too heavy to perform the computations in real time. A real-time approach to compute appropriate correction profiles may be preferable. In some examples, adding eccentricity and constraints of the eye positions and gaze sampling may provide an added advantage.

Taking into account gaze information and the drop off of sensitivity with eccentricity may help optimize required correction computations to the important areas and reduce memory size for the computation of correction coefficients. Accordingly, a potentially very large set of correction coefficients may be smaller and better compressed by optimizing the correction values. The approach may also result in optimizing a number of per frame computations for corrections because the mask areas may be weighted for perception. Further, knowing the gaze may allow a determination as to where to perform the computations for luminance non uniformity differently than chroma. Using color spaces such as IPT, where “I” (luminance) is well de-correlated, “I” may be addressed differently and with different masks and weights than PT.

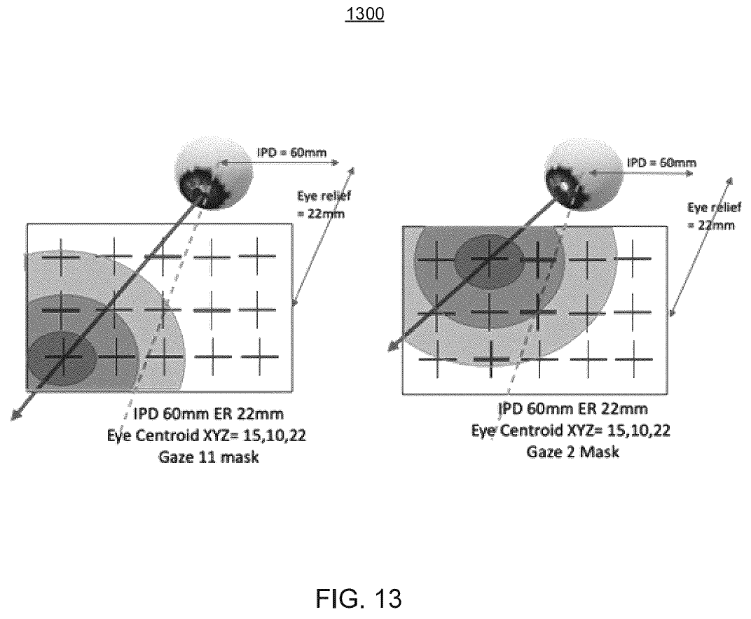

FIG. 13 illustrates how x, y, and z offsets of the eye centroid relative to the waveguide may change due to slippage of the glasses on the face of the user, according to examples. Diagram 1300 shows two example gaze masks for an IPD of 60 mm, eye relief of 22 mm, and eye centroid x, y, z values of 113, 10, and 22.

The x, y, and z offsets of the eye centroid relative to the waveguide may also change due to slippage of the glasses on the user's face. A first rough approximation may be to assume one nominal position is enough (no slippage). Further, a z slippage factor may be added and x, y assumed to remain the same or move with a fixed relationship given that IPD does not change. The limiting factor in considering all possible correction profiles (for all possible offsets, including the possibility of slippage) is likely to be memory space, as this is a very limited resource in small form factor near-eye display devices.

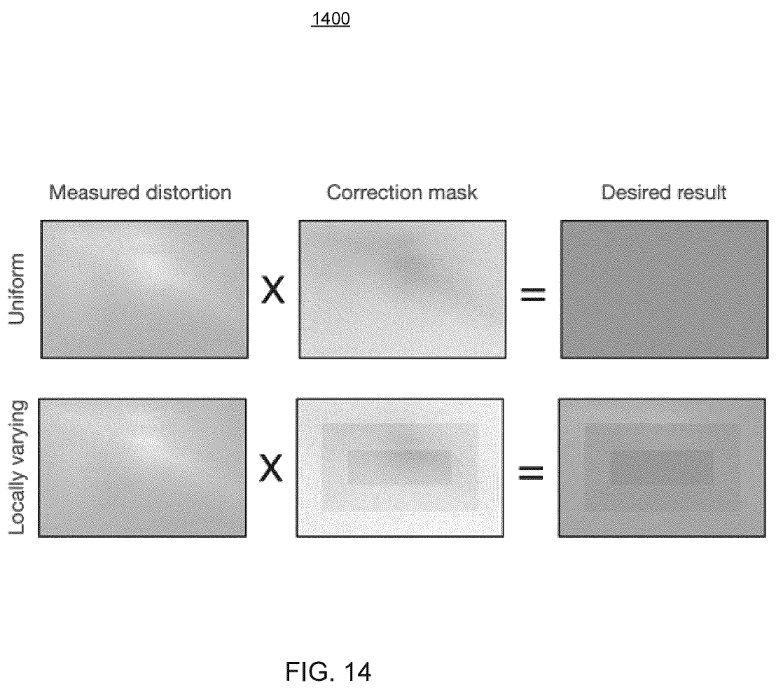

FIG. 14 illustrates measured distortion, correction mask, and desired results for different circumstances, according to examples. As shown in diagram 1400, an inverted correction mask may be computed for a given distortion profile such that when the mask is applied a resulting image shows little distortion. The profiles shown in the diagram 1400 are rectangular, but eccentricity gamma may be more accurately described using a circular area.

In some examples, because the correction is for the non-uniformity in a local region, the correction ratio to account for may be better than the non-uniformity range of the entire waveguide. For example, if modeling using a regular foveal color sensitivity threshold, the correction required for a region at 30 degrees of eccentricity may incur a loss-of-luminance multiplier of 4.6×. However, if the reduction in color sensitivity with eccentricity is taken into account, a different, lower multiplier of 2.2 may be sufficient to correct the image to the same expected level of visual quality. Correcting locally for 2.2:1 may be better (in terms of the achieved display luminance and contrast, as well as potential power usage) than correcting a global variance maximum, which may be 4.6:1 or more. Thus, significant dynamic range gains may be made. Another possible improvement may be saving memory space by placing fewer sample ratios per region (grouping more pixels together) as eccentricity increases.

The described technique may be an add-on to DUC augmenting the DUC with the ability to account for gaze eccentricity. Accordingly, correction tables may need to be accurate around the fixation points and may drop off allowing more color non-uniformity outside of the fixation points.

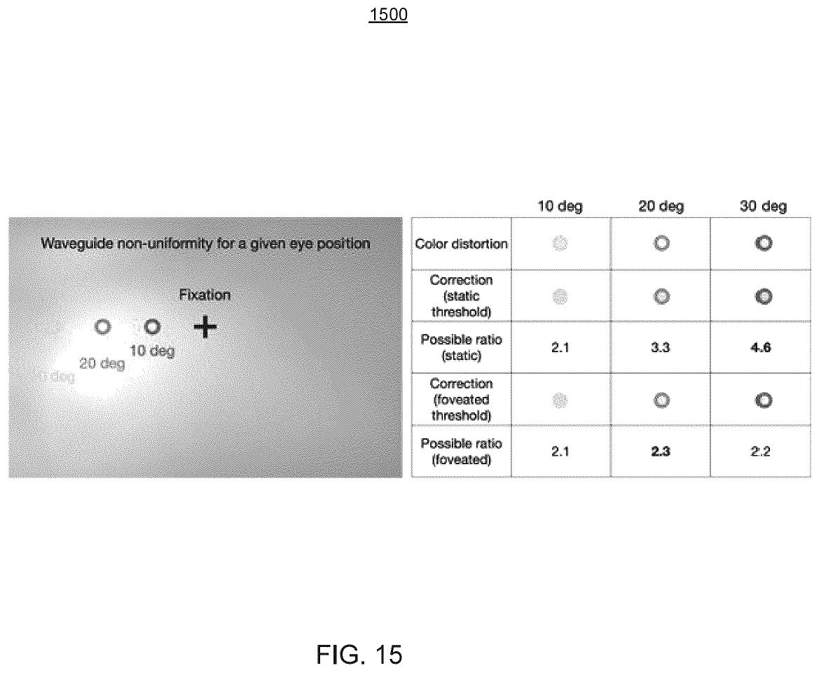

FIG. 15 illustrates how a foveated correction threshold may allow for lower overall ratios needed for correction, according to examples, according to examples. Diagram 1500 shows use of a foveated correction threshold that may allow for lower overall ratios needed for correction. In this example case, loosening the threshold at higher eccentricity may reduce the overall ratio needed to correct the image, freeing bit depth to be used for the content and increasing maximum possible luminance.

A challenge with just using eye tracking without knowing a centroid and IPD is that an assumption may need to be made that the eye may be in any position and have any gaze vector. Thus, every eye position x, y, z and the gaze vector may need to be computed for every new eye position and corresponding correction map. Instead of performing a light field computation per eye position in real time, if the eye fixation is at a point, then the IPD and centroid may be known and the z value from the foveal, parafoveal, and the peripheral regions for the eye may be used. Thus, the correction tables for a specific x, y fixation may be computed because there is only one x, y, z and gaze position for each fixation, and the correction map may assume accurate uniformity correction around that point and be more forgiving outside of the main foveal region.

In some approaches, a two-dimensional simplification may be performed by creating one set of corrections from measurements. In a proposed technique, the light field data may be used, and the two-dimensional correction may be computed based on a user's eye centroid during fitment. An assumption may be made that there are limited positions of a person's centroid given their IPD and nose size. Even with slippage, it may be assumed that there are limited positions the glasses can slip to. The z-plane dynamic correction tables may assume a different centroid for each z position.

In some examples, the true z-plane correction may be computed dynamically more than once a second. Then, the two-dimensional correction computation may be relaxed. Thus, the correction coefficients may be significantly more forgiving because outside the fixation, the correction may be very approximate due to lower color sensitivity.

According to examples, a method of improving pupil replication non-uniformity in waveguide displays is described herein. A system of improving pupil replication non-uniformity in waveguide displays is also described herein. A non-transitory computer-readable storage medium may have an executable stored thereon, which when executed instructs a processor to perform the methods described herein.

According to examples, a method of making a bifocal mixed reality pass-through camera is described herein. A system of making the bifocal mixed reality pass-through camera is also described herein. A non-transitory computer-readable storage medium may have an executable stored thereon, which when executed instructs a processor to perform the methods described herein.

According to examples, a method of correcting color non-uniformity artifacts that are generated by waveguides is described herein. A system of correcting color non-uniformity artifacts that are generated by waveguides is also described herein. A non-transitory computer-readable storage medium may have an executable stored thereon, which when executed instructs a processor to perform the methods described herein.

In the foregoing description, various examples are described, including devices, systems, methods, and the like. For the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples.

The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example” is not necessarily to be construed as preferred or advantageous over other embodiments or designs.

Although the methods and systems as described herein may be directed mainly to digital content, such as videos or interactive media, it should be appreciated that the methods and systems as described herein may be used for other types of content or scenarios as well. Other applications or uses of the methods and systems as described herein may also include social networking, marketing, content-based recommendation engines, and/or other types of knowledge or data-driven systems.

1. A waveguide-based display to control pupil replication density, comprising:
an image panel to provide light;
a projection lens to receive and focus the light from the image panel;
a variable aperture to pass the focused light in a controllable manner; and
a waveguide to project the focused light passed through by the variable aperture onto an eye box, wherein the variable aperture is positioned at an entrance of the waveguide.

2. The waveguide-based display of claim 1, wherein the variable aperture has a linear opening.

3. The waveguide-based display of claim 1, wherein the variable aperture has an arbitrary-shaped opening.

4. The waveguide-based display of claim 1, wherein the variable aperture and the image panel are synchronized.

5. The waveguide-based display of claim 1, further comprising:
a backlight, wherein the variable aperture and the backlight are synchronized.

6. The waveguide-based display of claim 1, further comprising:
an eye tracking camera, wherein the variable aperture and the image panel are synchronized based on a size or a location of a pupil determined by the eye tracking camera.

7. A camera assembly, comprising:
an optical assembly to:
receive a first light from a first object and a second light from a second object, wherein the first object is at a farther distance to the camera assembly compared to the second object; and
direct the first light in a first direction and the second light in a second direction; and
an infrared cut-off filter (IRCF) comprising a first portion and a second portion having a smaller thickness compared to the first portion, the IRCF to:
adjust an optical path of at least one of the first light and the second light through the first portion and the second portion; and
provide the optical path adjusted first light and the second light to two distinct portions of a camera sensor.

8. The camera assembly of claim 7, further comprising the camera sensor to capture images of the first object and the second object in the two distinct portions.

9. The camera assembly of claim 8, further comprising a processor to:
detect a tilt of the camera assembly; and
select one of the captured images of the first object and the second object for display to a user based on the tilt of the camera assembly.

10. The camera assembly of claim 9, wherein the processor is further to display the captured images of the first object and the second object side-by-side vertically or horizontally.

11. The camera assembly of claim 7, wherein the optical assembly comprises at least one optical lens.

12. The camera assembly of claim 11, wherein the at least one optical lens comprises a concave optical lens, a convex optical lens, a plano-concave optical lens, a plano-convex optical lens, or a concave-convex optical lens.

13. The camera assembly of claim 11, wherein the optical assembly comprises at least one of an optical filter, a polarizer, or a quarter wave plate.

14. A method, comprising:
determining an interpupillary distance (IPD) and centroids of a user's eyes;
determining a fovea of the user; and
generating a dynamic non-uniformity correction table comprising a plurality of correction coefficients based on a metric, wherein a threshold for the metric is reduced for coordinates outside the user's fovea.

15. The method of claim 14, wherein the metric is a color correction metric.

16. The method of claim 14, further comprising employing x, y, and z parameters for translational errors and α and β parameters for rotational errors.

17. The method of claim 14, further comprising comparing each coordinate to the user's gaze.

18. The method of claim 14, further comprising:
storing the plurality of correction coefficients in association with a user profile.

19. The method of claim 14, further comprising:
using the stored plurality of correction coefficients upon detecting a nominal position offset.

20. The method of claim 14, further comprising:
determining a slippage factor from a nominal position of a near-eye display device on a user's face.
